(19) United States
(12) Patent Application Publication
(10) Pub. No.: US 2007/0011070 A1
(43) Pub. Date: Jan. 11, 2007

(54) Fraud prevention system

(76) Inventor: Stewart Clements, Cambridge, MA (US)

Correspondence Address: LAW OFFICES OF KARL HORMANN, 86 SPARKS STREET, CAMBRIDGE, MA, 02138, US

(21) Appl. No.: 11/473,476

(22) Filed: Jun. 24, 2006

Related U.S. Application Data
(60) Provisional application No. 60/693,441, filed on Jun. 24, 2005.

(51) Int. Cl. G06Q 40/00; G06Q 99/00; H04L 9/00; H04K 1/00

(52) U.S. Cl. 705/35; 705/51

(57) ABSTRACT

A method of preventing the issue of credit on the basis of a fraudulently named person wherein the person enters in a data base instructions as to conditions under which credit may be issued to him and wherein the contents of the data base is scanned by a credit issuing institution to determine whether an application for credit submitted to it is in conformity with the instructions.

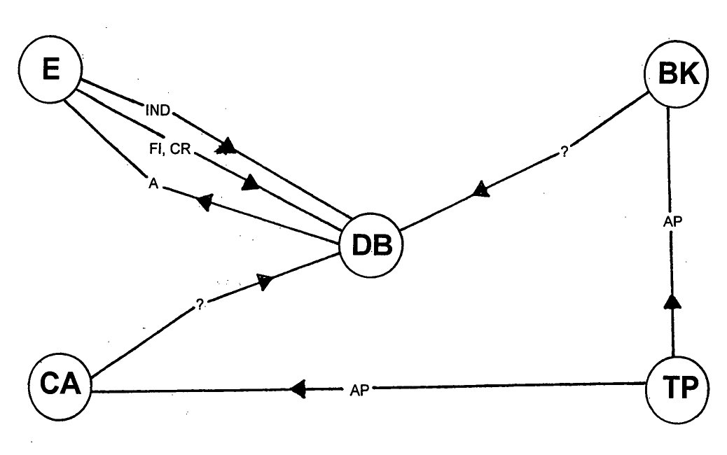

### REFERENCE TO RELATED APPLICATIONS

This application is based upon, and claims priority of, Provisional Application No. 60/693,441 filed 24 Jun. 2005.

### BACKGROUND OF THE INVENTION

1. Field of the Invention

The invention, in general, relates to protection from identity theft and, more particular, to a system for preventing fraudulent financial transactions based upon the unauthorized use by a third party of another person's identity.

2. The Prior Art

An unfortunate side-effect of computer-based information technology is the relative ease by which persons skilled in the art can obtain access to, or hack their way into, third parties' personal data, including such vital information as employment data, addresses, names of relatives, social security numbers, driver's license numbers, banks used, bank account numbers, credit ratings, etc., and wrongfully manipulate such data to the detriment of their true owners.

It is thus possible, for instance, wrongfully to draw upon whatever data may be required fraudulently to secure credit from lending institutions or to divert retirement and other payments from channels leading from appropriate government or investment agencies to their rightful payees and to convert such credit and payments to liquid assets before the deceit is discovered and prevented or the perpetrator is apprehended.

### OBJECTS OF THE INVENTION

It is an object of the invention to provide an authentic potential user of funds, whether they be credit from a lender or withdrawals from his own account at any bank or the like, an opportunity by his explicit instructions to prevent issuance of credit in his name or withdrawal of funds owned by him at least for a specified time and to absolve him of any responsibility in case credit has been issued or a withdrawal has occurred in contravention of his instructions.

In this connection, the right of an authentic potential user to bar dissemination of his credit rating to unauthorized third parties is considered an important element in the prevention of credit fraud.

### BRIEF SUMMARY OF THE INVENTION

In the simplest manner of accomplishing these and other objects, the invention provides for the establishment of a general depository, hereafter “data base” in which a properly authenticated person, hereafter “customer”, can enter, and lenders, disbursers, credit rating and governmental agencies, hereafter collectively “financial institution”, can obtain, in real time, the customer's instructions that credit be issued in his name, disbursements be made from accounts of his and information relating to his credit rating be released to third parties subject to stipulated conditions only. The conditions may be, for instance, that no credit be issues at all, that no disbursements be made and that no information be given to third parties as to his credit rating. The instructions are such that while they are accessible to anyone, they can be altered or repealed only by the customer.

Advantageously, before any such instructions can be stored in the data base, the customer would register with the data base by storing therein, in addition to conventional identification data such as his name and address, identifying indicia which are unique to him, such as a recording of his voice pattern, an image of his fingerprints or of his iris, or a sample of his DNA and which, for reasons of safety, can neither be accessed nor altered or copied by anyone but the customer. If anyone else were to gain access to the identifying indicia, they would immediately self-destruct. In return, the data base may issue, or the customer may select, an access code or PIN (personal identification number) which he may make known to the financial institutions commonly used by him and which may be used to facilitate access to the customer's instructions stored in the data base.

The identifying indicia would be coupled to the customer entering his instructions in the data base, i.e. the data base would compare the identifying indicia stored in it against the customer's identifying indicia presented currently upon entry of instructions in order to ensure the authenticity of the customer and thus of the instructions entered by him. Once the authenticity of the customer has been established by a match between the initial identifying indicia and the currently obtained identifying indicia, the instructions can be entered in the data base, and any financial institution can review the instructions and act in accordance therewith since even without knowledge of the customer's identifying indicia, the financial institution can assume the instructions to be genuine. The customer's PIN may be relied upon not only as an additional safety feature but also to facilitate identification of the customer.

Advantageously, the data base is an impartial entity independent of financial institutions, and in the manner aforesaid it can be manipulated for entry of instructions only by a customer authenticated by way of his identifying indicia such as, for instance, the customer's fingerprints, iris, voice pattern or DNA sample, and which can be accessed by financial institutions for real time retrieval of the customer's instructions only. The data base could be a facility maintained for the benefit of the public and of financial and government institutions.

Customers as well as financial institutions would have access to the data base by computer or telephone; but only the customer can enter and change his instructions. Furthermore, a financial institution to which an application for credit or funds has been presented in the name of a customer would search the data base to establish whether the application is at variance with possible instructions by the customer in the data base and if it is found to be at variance, the financial institution would not only reject the application but also take whatever else it deems necessary to ward off possible fraud. For the prevention of possible fraudulent “insider activities” every search of the data base by a financial Institution or credit rating agency would be automatically logged in the data in an unerasable manner for retrieval by the customer.

### DESCRIPTION OF THE DRAWING

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawing which represents a schematic rendition of the system in accordance with the invention.

### DETAILED DESCRIPTION OF THE PREFERRED EMBODIMENTS

In the simplest way of practicing the invention a customer, i.e. a potential victim of identity theft and fraudulent financial actions based thereon, would enter into a central data base, by way of his personal identification number or code, a statement or instructions in an appropriate format stipulating conditions under which he is prepared to accept credit. Among such conditions may be an instruction that no credit must be issued by anyone under his name. The customer may be a natural person or a juridical person.

Advantageously, however, and in view of the fact that personal identification numbers or codes (PIN) can be easily discovered or obtained, the customer's access to the data base for purposes of entering such a statement or instructions is further conditioned upon the prior entry in the data base by him of unalterable identifying indicia unique to him such as, for example, a recording of his voice or an image of his fingerprints and/or iris or a DNA sample. Such identifying indicia may be stored in a self-destructive format so that any tampering with the indicia by a third party would result in their immediate destruction and, hence, in the data base being inaccessible. Preferably, the identifying indicia are accessible to the customer only, but not to financial institutions or anyone else. Since without these indicia, instructions cannot be entered in the data base, financial institutions can rely upon instruction in the data base as being authentic and originating with the customer who has entered them. Once the customer's instructions have been entered in the data base, they are accessible for review, but not for alteration, by financial institutions. An identification code assigned to the customer is used initially to identify the customer, but his authenticity will be determined by comparing his initially stored identifying indicia to currently provided indicia. Such access is necessary whenever an application for credit or funds has been submitted to the financial institution in the customer's name. If the application contravenes instructions stored in the data base it may be presumed fraudulent and the financial institution could take appropriate countermeasures to prevent the fraud from being perpetrated. As set forth supra, searching of the data base by a financial institution or credit rating agency is automatically logged in the data base.

In the sole drawing, a customer E is schematically seen to enter in a data base DB unalterable identifying indicia IND of the kind referred to as a quasi-permanent record. This would preferably take place under the supervision of a person who could certify the customer's authenticity. The indicia is such that only the customer can access it. Access to the identifying indicia by anyone else would cause their immediate destruction. Subsequently, the customer E may enter instructions FI in the data base DB relating to his willingness to assume or not to assume credit from any lending institution BK, to allow or not allow withdrawals from his bank accounts or disbursement of funds to which he is entitled, such as medical insurance deductible from his social security. Further instructions CR may be entered, either separately or automatically, for use by so-called credit rating agencies CA directing them not to reveal the customer's credit rating to any third party except by the customer's express authorization. These latter instructions are believed vital as they would deprive a potential perpetrator of financial fraud of information relating to the financial standing of the customer and thus of a basic tool for evaluating the potential success of an application for credit. The data base DB would issue an acknowledgment A, preferably together with a PIN of the kind which the customer may change, to the customer E of having received instructions FI and CR. The customer's instructions FI, CR may be likened to a “firewall” in the sense that they filter out and reject fraudulent credit applications, financial claims or requests for credit ratings (hereafter collectively “application) AP in the customer's name by a third party TP since financial institutions BK or credit rating agencies CA, before even considering an application AP, would query, as indicated by ?, the data base DB for instructions FI, CR from the customer E. The presence of a genuine customer's instructions FI, CR in the data base DB which conflicts with the application AP would put the financial institution BK or credit rating agency CA in a position to reject the application AP and to take whatever remedial steps it deems appropriate. The presence in the data base DB of the genuine customer's instructions would also shift the responsibility for any erroneously issued credit or satisfied claims contrary to the customer's instructions from the customer to the financial institution.

The depository or data base DB is preferably administered by an impartial and independent party for the benefit of the public. It must be capable of initially receiving and storing, for access only by the customer, a permanent record of the customer's identifying indicia such as, for instance, images of his fingerprint and of his iris, a record of his voice pattern and possibly a sample of his DNA. It must also be capable of comparing the initially recorded indicia with the customer's currently submitted indicia for purposes of confirming the authenticity of the customer and thereby accept the instructions or of rejecting the instructions in case the currently submitted identifying indicia do not match the originally stored indicia. The apparatus required for receiving and recording data representative of the initially submitted identifying indicia and for their subsequent comparison with currently received identifying indicia is well known in the art and is believed not to require any specific description. While a customer may initially have to enter his identifying indicia in the data base DB in the presence of a person capable of verifying the authenticity of the customer, subsequent communication by the customer with the data base DB can take place by video-telephones or over the internet by computers equipped with appropriate video and audio features.

Assuming a customer E does not wish to obtain money by way of credit, to have money disbursed from any bank accounts or government agencies or have his credit rating disclosed, the customer E, after having identified himself to the data base DB in the aforesaid manner, enters instructions FI, CR to that effect in the data base DB. Such instructions are then immediately available to financial institutions, government agencies and credit rating agencies which could otherwise become the targets of fraudulent applications or requests for credit or funds and thus prevent those institutions and agencies from issuing unauthorized credit, make unauthorized disbursements in the name and from accounts of customer E.

The instructions FI and CR would protect both the financial institutions and the customer from subsequently filed credit applications or claims fraudulently submitted by a third party in the customer's name and may serve to absolve the customer E from any responsibility for credit issued and disbursements made in contravention of his instructions.

What is claimed is:

1. A method of preventing the wrongful issuance of credit, comprising the steps of:
providing a data base connected for selective access to at least one credit issuing institution and at least one customer;
storing in the data base at least one element of personal identification of the customer; and
having the customer entering in the data base instructions for access to the credit issuing institution relating to conditions of credit in the name of the customer.

2. The method of claim 1, wherein the element of personal identification comprises a personal identification code accessible to the customer and to the credit issuing institution.

3. The method of claim 2, wherein the element of personal identification further comprises an unalterable identifying indicium unique and accessible only to the customer.

4. The method of claim 3, wherein the entering of instructions in the data base comprises the further step of entering in the data base identifying indicium substantially identical to the identifying indicium stored in the data base.

5. The method of claim 4, wherein the identifying indicium comprises a voice pattern of the customer.

6. The method of claim 4, wherein the identifying indicium comprises a finger print of the customer.

7. The method of claim 4, wherein the identifying indicium comprises an image of an iris of the customer.

8. The method of claim 4, wherein the identifying indicium comprises a DNA sample of the customer.

9. The method of claim 8, wherein the identifying indicium is self-destructive when accessed by someone other than the customer.

10. The method of claim 1, further including the step of rejecting an application for credit contravening the customer's instructions.

11. The method of claim 1, wherein access to the customer's instructions in the data base by the credit issuing institution is automatically logged in the data base.
